(19) United States
(12) Patent Application Publication
(10) Pub. No.: US 2012/0021185 A1
(43) Pub. Date: Jan. 26, 2012

(54) GLASS SHEET

(75) Inventors: Dominique Sachot, Ozoir La Ferriere (FR); Octavio Cintora, Taverny (FR); Olivier Mario, Paris (FR)

(73) Assignee: SAINT-GOBAIN GLASS FRANCE, Courbevoie (FR)

(21) Appl. No.: 13/202,662

(22) PCT Filed: Feb. 22, 2010
(86) PCT No.: PCT/FR2010/050298

§ 371 Date: Oct. 4, 2011

(30) Foreign Application Priority Data
Feb. 27, 2009 (FR) 0951242

(51) Int. Cl. B32B 3/00; B32B 17/06; C03C 3/078; C03C 3/089; C03C 3/091; C03C 3/087; C03C 3/00; C03C 3/04

(52) U.S. Cl. 428/174; 501/11; 428/426; 501/53; 501/65; 501/66; 501/70; 501/72

(57) ABSTRACT

The subject of the invention is a glass sheet, the light transmission of which is greater than or equal to 89% for a thickness of 3.2 mm and the chemical composition of which comprises bismuth oxide in a weight content between 0.05 and 1%.

The invention relates to the field of flat or curved glass sheets. More specifically, the invention relates to glass compositions and to a process for obtaining glass sheets.

The glass sheets are used in numerous applications: glazing units for buildings or motor vehicles, energy production, especially photovoltaic systems or mirrors for concentrating solar energy, display screens, etc.

For most of these applications, the chemical homogeneity of the glass is an essential feature. This is because the presence of heterogeneities is capable of creating optical defects. These heterogeneities may be gaseous inclusions (bubbles, “seeds”) or solid inclusions (“stones”, batch stones), or areas of different chemical composition (some are described as “cords” in the field). Regardless of the application, the presence of optical defects should be avoided, and the glass preparation processes endeavor to limit this risk.

The glass sheets are generally produced in the following manner: pulverulent batch materials which are natural (sand, limestone, dolomite, feldspars, etc.) or are derived from the chemical industry (sodium carbonate) are introduced into a furnace heated with the aid of at least one generally overhead burner or with the aid of resistors immersed in the glass bath. Under the effect of the heat, melting reactions and chemical reactions between the various components of the batch materials will form a molten glass bath. The homogenization of the glass bath then takes place according to several mechanisms. Generally, a refining agent is introduced with the batch materials. This is a chemical compound, or a mixture of compounds, for example sodium sulfate or calcium sulfate (gypsum), which will generate a gaseous release within the glass bath. This gaseous release helps to locally homogenize the glass by facilitating the digestion of the residual silica grains and the evacuation of the gases trapped within the glass bath. Powerful thermal convection movements due to the difference in temperature between the surface of the glass and the floor of the furnace also help to homogenize the glass. Sometimes mechanical means are installed, such as stirrers or bubblers that generate gas bubbles within the glass bath.

Glass having a high light and energy transmission, often referred to as “extra-clear” or “ultra-clear” glass, is particularly difficult to homogenize. This glass contains small amounts of iron oxide, and in particular small amounts of ferrous iron (Fe²⁺). Therefore, the absorption of the radiation from the flames by the glass is particularly low, the result of which is a small difference in temperature between the surface of the glass and the floor of the furnace, and therefore convection movements of reduced intensity. Moreover, the glass is often refined using sulfate (sodium or calcium sulfate) and a reducing agent such as coke. Due to its effect on the sulfate at relatively low temperature, the reducing agent greatly assists the refining and the homogenization of the glass bath from the first steps of the melting process. However, the presence of reducing agents is prejudicial for the production of extra-clear glass, as it results in a high proportion of ferrous iron, which absorbs the light radiation for wavelengths located in the visible range and near infrared range and therefore reduces the transmission of the final product.

The inventors have now found a solution to the problem of the homogenization of glass having high light and energy transmission.

One subject of the invention is a glass sheet, the light transmission of which is greater than or equal to 89% for a thickness of 3.2 mm, and the chemical composition of which comprises bismuth oxide in a weight content between 0.05 and 1%.

Within the meaning of the invention, the light transmission, often abbreviated to “T_{L}”, is calculated between 380 and 780 nm and related to a glass thickness of 3.2 mm, taking into consideration the illuminant D65 as defined by the ISO/CIE 10526 standard and the CIE 1931 standard colorimetric observer as defined by the ISO/CIE 10527 standard.

Indeed the inventors have demonstrated that the addition of bismuth oxide in the amounts claimed made it possible to improve the chemical homogeneity of the glass, particularly glass with a high light transmission. Therefore, the glass obtained has a higher light or energy transmission, which is particularly appreciable for the glass used in the field of photovoltaics or mirrors for concentrating solar energy. The mechanism of action of the bismuth is completely unknown and misunderstood.

The glass sheet according to the invention preferably has a chemical composition of soda-lime-silica type, for reasons of ease of melting and processing. However, other types of glass may be used, in particular glass of borosilicate, aluminosilicate or aluminoborosilicate type.

The expression “composition of soda-lime-silica type” is understood to mean a composition comprising silica (SiO₂) as a forming oxide and sodium oxide (soda, Na₂O) and calcium oxide (lime, CaO). This composition preferably comprises the following constituents in contents varying within the weight limits defined below:

| | |
|---|---|
| SiO₂ | 60-75% |
| Al₂O₃ | 0-10% |
| B₂O₃ | 0-5%, preferably 0 |
| CaO | 5-15% |
| MgO | 0-10% |
| Na₂O | 5-20% |
| K₂O | 0-10% |
| BaO | 0-5%, preferably 0. |

The glass sheet according to the invention is preferably such that its light transmission is greater than or equal to 90%, in particular 90.5%, or even 91%, for a thickness of 3.2 mm.

The glass sheet according to the invention is preferably such that its energy transmission (T_{E}) calculated according to the ISO 9050 standard (air mass 1.5) is greater than or equal to 90%, in particular 90.5%, or even 91%, for a thickness of 3.2 mm.

The chemical composition of the glass sheet according to the invention preferably comprises iron oxide in a weight content, expressed as Fe₂O₃, between 0.005% and 0.05%, in particular between 0.007% and 0.02%. Such contents make it possible to achieve high light transmissions. Contents lower than 0.005% are however difficult to obtain since they imply a very advanced, and therefore expensive, purification of the batch materials.

The presence of iron in a glass composition may result from the batch materials, as impurities, or as a deliberate addition that aims to color the glass. It is known that iron exists in the glass structure in the form of ferric ions (Fe³⁺) and of ferrous ions (Fe²⁺). The presence of Fe³⁺ ions gives the glass a very slight yellow coloration and enables it to absorb ultraviolet radiation. The presence of Fe²⁺ ions gives the glass a more pronounced blue/green coloration and induces absorption of infrared radiation. The increase of the iron content in both its forms accentuates the absorption of radiation at the ends of the visible spectrum, this effect taking place to the detriment of the light transmission.

The composition of the glass sheet according to the invention is preferably such that the redox is less than or equal to 0.4, in particular 0.3, and even 0.2 or 0.1. The redox of the glass is defined within the meaning of the present invention as being the ratio between the weight content of ferrous iron oxide (expressed as FeO) and the weight content of total iron oxide (expressed as Fe₂O₃). Indeed, low redox values make it possible to increase the energy transmission of the glass.

In order to achieve these low redox values and/or these high energy transmissions, various means are possible. The glass sheet according to the invention may especially contain tungsten oxide WO₃ in a weight content between 0.1 and 2%, as taught in application FR 2921356. It may also contain potassium oxide in a weight content between 1.5 and 10%, as taught in application FR 2921357.

The chemical composition of the glass sheet according to the invention preferably comprises bismuth oxide in a weight content between 0.1 and 0.5%, in particular between 0.1% and 0.3%. Above 0.5%, it appears that the addition of bismuth oxide gives only a limited effect, as if there was a saturation phenomenon.

The glass sheet according to the invention is preferably flat or curved. It is advantageously curved with a cylindro-parabolic shape when it is intended to be used for the manufacture of parabolic mirrors for concentrating solar energy. The glass sheet according to the invention may be of any size, generally between 0.5 and 6 m. Its thickness is generally between 1 and 10 mm.

The glass composition may comprise, besides the inevitable impurities contained, in particular, in the batch materials, a small proportion (up to 1%) of other constituents, for example agents that aid the melting or the refining of the glass (SO₃, Cl, etc.), or else elements that originate from the dissolution of the refractories that are used in the construction of the furnaces (for example, ZrO₂). The composition according to the invention preferably does not comprise oxides such as Sb₂O₃, As₂O₃ or CeO₂. Preferably, the MoO₃ content is zero.

The composition of the glass sheet according to the invention preferably does not comprise any agent that absorbs visible or infrared radiation (especially for a wavelength between 380 and 1000 nm) other than those already cited. In particular, the composition according to the invention preferably does not contain agents chosen from the following agents, or any of the following agents: transition element oxides such as CoO, CuO, Cr₂O₃, MnO₂, rare-earth oxides such as CeO₂, La₂O₃, Nd₂O₃, or else coloring agents in the elemental state such as Se, Ag, Cu, Au. These agents very often have a very powerful undesirable coloring effect, which is manifested at very low contents, sometimes of around a few ppm or less (1 ppm=0.0001%). Their presence thus very strongly decreases the transmission of the glass. For certain applications, in particular in furniture, it is however possible to add a very small amount of a coloring oxide, in particular cobalt oxide in a content less than 1 ppm, to give a slight coloration visible at the edge of the glass. The chemical composition of the glass sheet according to the invention therefore preferably does not comprise gold or silver.

Another subject of the invention is a process for obtaining a glass sheet according to the invention, comprising a melting step in which a bismuth oxide precursor compound is introduced.

This compound may, for example, be bismuth oxide Bi₂O₃ or a precursor such as bismutite ((BiO)₂CO₃), or bismuth nitrate (Bi(NO₃)₃).

The melting may be carried out in continuous furnaces, heated with the aid of electrodes and/or with the aid of burners, which are overhead burners and/or submerged burners and/or burners positioned in the crown of the furnace so that the flame impacts the batch materials or the glass bath. The batch materials are generally pulverulent and comprise natural materials (sand, feldspars, limestone, dolomite, nepheline syenite, etc.) or synthetic materials (sodium carbonate or potassium carbonate, boric anhydride, sodium sulfate, etc.). The batch materials are loaded into the furnace then undergo melting reactions in the physical sense of the term and various chemical reactions that lead to a glass bath being obtained. The molten glass is then conveyed to a forming step during which the glass sheet will take up its shape. The forming may be carried out by various methods, such as the float process (in which the glass is poured onto a bath of molten tin), the rolling process, drawing out, etc. The rolling process, in which the glass passes between casting rolls, is particularly useful for forming reliefs at the surface of the glass. The glass sheet can then be cut, shaped, bent, toughened, etc.

The glass sheet according to the invention may be coated on at least one of its faces with at least one thin layer or at least one multilayer providing at least one additional functionality: antireflection layer or on the contrary reflective layer (for example layer of silvering for mirrors), conductive layer (based, for example, on fluorine-doped or antimony-doped tin oxide, or on aluminum-doped or gallium-doped zinc oxide, or on mixed indium tin oxide), low-emissivity layer or solar-protection layer (based, for example, on silver, generally protected by other layers), antifouling layer or self-cleaning layer (based, for example, on titanium oxide, especially crystallized in anatase form). If the glass sheet is intended to be used in mirrors, especially mirrors for concentrating solar energy, the sheet is coated with a layer of silver, which is protected against oxidation by at least one layer of paint.

A final subject of the invention is the use of the glass sheet according to the invention in photovoltaic cells, solar cells, flat or parabolic mirrors for concentrating solar energy, or else diffusers for backlighting display screens of the LCD (liquid crystal display) type. The glass sheet according to the invention may also be used for interior applications (partitions, furniture, etc.) or in electrical goods (refrigerator shelves, etc.). It may also be used in flat lamps or screens based on organic light-emitting diodes.

Generally, another subject of the invention is a photovoltaic cell, a solar cell, a flat or parabolic mirror for concentrating solar energy, or else a diffuser for backlighting display screens of the LCD type comprising at least one glass sheet according to the invention.

In the case of applications in the field of photovoltaics, and in order to maximize the energy efficiency of the cell, several improvements may be made, cumulatively or alternately:
the glass sheet may advantageously be coated with at least one thin transparent and electro-conductive layer, for example based on SnO₂:F, SnO₂:Sb, ZnO:Al, ZnO:Ga. These layers may be deposited onto the substrate by various deposition processes, such as chemical vapor deposition (CVD) or deposition by sputtering, especially when enhanced by a magnetic field (magnetron sputtering process). In the CVD process, halide or organometallic precursors are vaporized and transported by a carrier gas to the surface of the hot glass, where they decompose under the effect of the heat to form the thin layer. The advantage of the CVD process is that it is possible to use it within the process for forming the glass sheet, especially when it is a float process. It is thus possible to deposit the layer at the moment when the glass sheet is on the tin bath, at the outlet of the tin bath, or else in the lehr, that is to say at the moment when the glass sheet is annealed in order to eliminate the mechanical stresses. The glass sheet coated with a transparent and electroconductive layer may be, in turn, coated with a semiconductor based on amorphous or polycrystalline silicon, on chalcopyrites (especially of the CIS—CuInSe₂ type) or on CdTe in order to form a photovoltaic cell. It may especially be a second thin layer based on amorphous silicon, on CIS or on CdTe. In this case, another advantage of the CVD process lies in obtaining a greater roughness, which generates a light-trapping phenomenon, which increases the amount of photons absorbed by the semiconductor.
the glass sheet may be coated on at least one of its faces with an antireflection coating. This coating may comprise a layer (for example based on porous silica having a low refractive index) or several layers: in the latter case a multilayer made up of layers based on a dielectric material that alternates between layers having low and high refractive indices and that terminates with a layer having a low refractive index is preferred. It may especially be a multilayer described in Application WO 01/94989 or WO 2007/077373. The antireflection coating may also comprise, as the last layer, a self-cleaning and antifouling layer based on photocatalytic titanium oxide, as taught in Application WO 2005/110937. It is thus possible to obtain a low reflection that is long-lasting. In applications in the field of photovoltaics, the antireflection coating is positioned on the outer face, that is to say the face in contact with the atmosphere, whilst the optional transparent electroconductive layer is positioned on the inner face, on the side of the semiconductor.
the surface of the glass sheet may be textured, for example have motifs (especially pyramid-shaped motifs), as described in Applications WO 03/046617, WO 2006/134300, WO 2006/134301 or else WO 2007/015017. These texturings are in general obtained using a rolling process for forming the glass.

The present invention will be better understood on reading the following detailed description of non-limiting exemplary embodiments.

Table 1 below indicates the chemical composition of a comparative glass sheet (Cl) and of glass sheets according to the invention (1 and 2), and their optical properties:
the energy transmission factor (T_{E}), calculated according to the ISO 9050 standard (air mass 1.5);
the overall light transmission factor (T_{L}), calculated between 380 and 780 nm, taking into consideration the illuminant D65 as defined by the ISO/CIE 10526 standard and the C.I.E. 1931 standard colorimetric observer as defined by the ISO/CIE 10527 standard.

All the contents are weight contents.

TABLE 1

| | C1 | 1 | 2 |
|---|---|---|---|
| SiO₂ (%) | 71.79 | 71.59 | 71.39 |
| Al₂O₃ (%) | 0.8 | 0.8 | 0.8 |
| CaO ( % ) | 9.0 | 9.0 | 9.0 |
| MgO (%) | 4.0 | 4.0 | 4.0 |
| Na₂O (%) | 14.1 | 14.1 | 14.0 |
| Fe₂O₃ (%) | 0.01 | 0.01 | 0.01 |
| SO₃ (%) | 0.3 | 0.3 | 0.3 |
| Bi₂O₃ (%) | — | 0.2 | 0.5 |
| T_{E} (%) | 90.6 | 90.8 | 90.8 |
| T_{L} (%) | 90.8 | 91.1 | 91.1 |

The analysis of the optical spectra shows that bismuth oxide has no effect on the redox of the glass, but only on the light and energy transmissions.

1. A glass sheet, comprising a chemical composition between 0.05 and 1.00% by weight of bismuth oxide, wherein the light transmission of the glass sheet is greater than or equal to 89% for a thickness of 3.2 mm, taking into consideration illuminant D65.

2. The glass sheet of claim 1, wherein the chemical composition is of soda-lime-silica type.

3. The glass sheet of claim 1, wherein the chemical composition further comprises the following constituents in the contents varying within the weight limits defined below:

| | |
|---|---|
| SiO₂ | 60-75% |
| Al₂O₃ | 0-10% |
| B₂O₃ | 0-5% |
| CaO | 5-15% |
| MgO | 0-10% |
| Na₂O | 5-20% |
| K₂O | 0-10% |
| BaO | 0-5%. |

4. The glass sheet of claim 1, wherein the chemical composition further comprises iron oxide, Fe₂O₃, in a weight content, between 0.005% and 0.05%.

5. The glass sheet of claim 1, wherein the redox is less than or equal to 0.2.

6. The glass sheet of claim 1, wherein the weight content of bismuth oxide is between 0.1 and 0.5%.

7. The glass sheet of claim 1, wherein the chemical composition further comprises tungsten oxide WO₃ in a weight content between 0.1 and 2%.

8. The glass sheet of claim 1, wherein the chemical composition further comprises potassium oxide in a weight content between 1.5 and 10%.

9. The glass sheet of claim 1, wherein the light transmission of the glass sheet is greater than or equal to 90% for a thickness of 3.2 mm, taking into consideration the illuminant D65.

10. The glass sheet of claim 1, wherein the chemical composition does not comprise gold or silver.

11. The glass sheet of claim 1, wherein the glass sheet is flat or curved.

12. The glass sheet of claim 1, wherein the glass sheet is coated on at least one of its faces with at least one thin layer or at least one multilayer, providing at least one additional functionality, selected from the group consisting of an antireflection layer, a reflective layer, a conductive layer, a low-emissivity or solar-protection layer, and an antifouling or self-cleaning layer.

13. A process for obtaining the glass sheet of claim 1, the process comprising melting batch materials and introducing a bismuth oxide precursor compound.

14. A device comprising the glass sheet as of claim 1, wherein the device is selected from the group consisting of a photovoltaic cell, a solar cell, a flat or parabolic mirror for concentrating solar energy, a diffuser for backlighting display screens of an LCD (liquid crystal display).

15. The device of claim 14, wherein the device comprises at least one glass sheet.

16. The glass sheet of claim 3, wherein the chemical composition further comprises 0% B₂O₃.

17. The glass sheet of claim 3, wherein the chemical composition further comprises 0% BaO.

18. The glass sheet of claim 3, wherein the chemical composition further comprises 0% B₂O₃ and 0% BaO.

19. The glass sheet of claim 1, wherein the chemical composition further comprises iron oxide, Fe₂O₃, in a weight content between 0.007% and 0.02%.

20. The glass sheet of claim 1, wherein the redox is less than or equal to 0.1.

21. The glass sheet of claim 1, wherein the light transmission of the glass sheet is greater than or equal to 91% for a thickness of 3.2 mm, taking into consideration the illuminant D65.

22. The glass sheet of claim 1, wherein the glass sheet is cylindro-parabolic in shape.
